(19) United States
(12) Patent Application Publication
(10) Pub. No.: US 2009/0083411 A1
(43) Pub. Date: Mar. 26, 2009

(54) SYSTEM AND METHOD FOR REMOTE CONTROL OF MULTIPLE DEVICES

(76) Inventors: Sawa Takano, Fujisawa-shi (JP); Kohji Takano, Fujisawa-shi (JP)

Correspondence Address: HOFFMAN WARNICK LLC, 75 STATE ST, 14TH FLOOR, ALBANY, NY, 12207, US

(21) Appl. No.: 11/858,189

(22) Filed: Sep. 20, 2007

(51) Int. Cl. G06F 15/173

(52) U.S. Cl. 709/224

(57) ABSTRACT

The present invention is a system and method for operating multiple devices using a new remote control method. The following new techniques are illustrated for operating multiple devices using the remote control method of the present invention comprising the steps of operating multiple devices simultaneously; and performing an operation checked on one device on multiple other devices. In addition, the system and method of the present invention has four new concepts ideas for improving operation on multiple devices transmitting to multiple devices simultaneously; detecting differences in the result screens and displaying the differences in a different color; checking on one device on multiple other devices; and automatically detecting unexpected operation results and stopping the operation.

### FIELD OF THE INVENTION

The present invention relates generally to remote devices and, more specifically, to a system and method for remotely controlling multiple devices.

### BACKGROUND OF THE INVENTION

In general, a remote control method is used to display the screens of multiple devices that are connected via a network on one PC (personal computer) and to operate and control them. For example, Windows XP Professional Remote Desktop, Desktop On-Call (http://www.ifour.co.jp/product/doc55/), VNC (http://www.realvnc.com/), MultiVNC (http://itpro.nikkeibp.co.jp/free/ITPro/NEWS/20050207/155819/), etc., are available as remote control software. Using these software applications, it is only possible for one device from among the devices located in remote places to be operated at one time. For example, MultiVNC possesses functions for displaying the screens of multiple PCs and transmitting images to multiple PCs. However, the software cannot operate multiple PCs simultaneously. By turning on the “Operation ON/OFF” button, the mouse or keyboard operations performed on the local PC are performed on one designated PC. Only one local device can be operated at one time. Therefore, when a user wants to perform a common operation on multiple devices, the user needs to activate one device screen after another and perform the same operation on each screen. For example, for use in in-house education, if the user wishes to configure the same settings on 30 PCs, for which functions other than their operating systems have not yet been set, using the conventional remote control method, the user will encounter the problem of having to repeat the same operation 30 times.

The problems with the prior art are:
1) An operation can be performed only on one device at a time, the same operation must be repeated according to the number of devices; and
2) The difference between each remote device screen cannot be identified at a glance.

There presently is a need for a system and method for operating multiple devices using a new remote control method.

### BRIEF SUMMARY OF THE INVENTION

The present invention is a system and method for operating multiple devices using a new remote control method.

The following new techniques are illustrated for operating multiple devices using the remote control method of the present invention comprising the steps of:
1) operating multiple devices simultaneously; and
2) performing an operation checked on one device on multiple other devices.

In addition, the system and method of the present invention has four new concepts ideas for improving operation on multiple devices:
1. transmitting to multiple devices simultaneously;
2. detecting differences in the result screens and displaying the differences in a different color;
3. checking on one device on multiple other devices; and
4. automatically detecting unexpected operation results and stopping the operation.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts the block diagram of the conventional functions of the present invention.

FIG. 2 shows the functional block diagram of the present invention.

FIG. 3 illustrates the operation PC screen example (first screen) of the present invention.

FIG. 4 illustrates the operation PC screen example (screen displayed after the devices to be operated have been selected) of the present invention.

FIG. 5 illustrates the operation PC screen example (flow of operation transmission when an operation is performed) of the present invention.

FIG. 6 illustrates the operation PC screen example where the difference is displayed in comparison with the images on the operation screen of the present invention.

FIG. 7 illustrates the functional block diagram of operation save of the present invention.

FIG. 8 illustrates the screen for operation save of the present invention.

FIG. 9 illustrates the reproduction function block diagram of the present invention.

FIG. 10 illustrates the screen of reproduction of the present invention.

FIG. 11 illustrates the Table 1 of items to be saved of the present invention.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method for a remotely controlling multiple devices. The system and method of the present invention is best explained by classifying them into two methods.

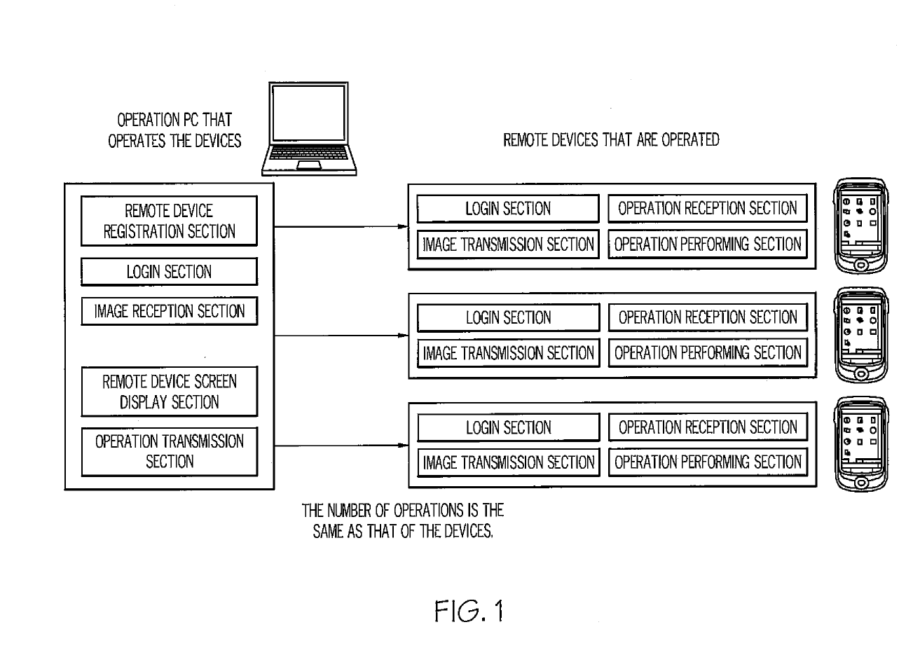

N-plex screens, for supporting n-plex devices which are located in remote places and one screen on which remote operation is performed (hereafter referred to as “operation screen”) are displayed on a local PC display as (n+1)-plex screens. (“plex” is a suffix meaning divided into a specified number of parts as in “fourplex”, “triplex” etc.) An operation that is performing on the operation screen (for example, moving the cursor and clicking the folder icon) is transmitted to and performed on the n-plex devices. The operation situation is displayed in realtime on the n-plex screens of the local PC. The present invention has n-plex (multiple) devices that are to be operated simultaneously. This is shown in FIGS. 1-11.

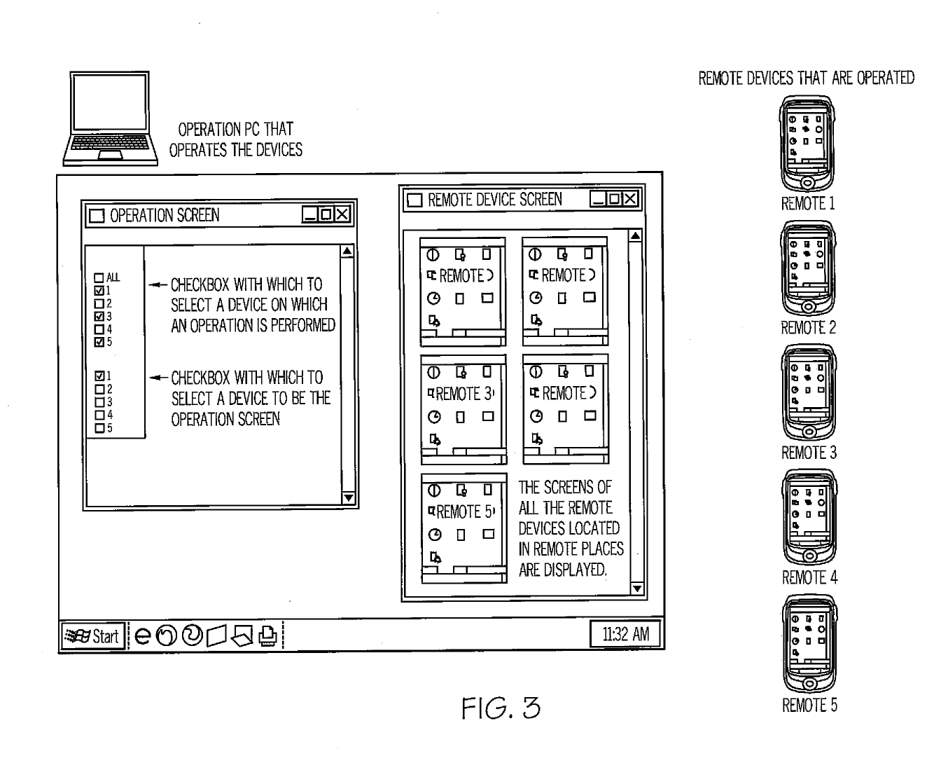

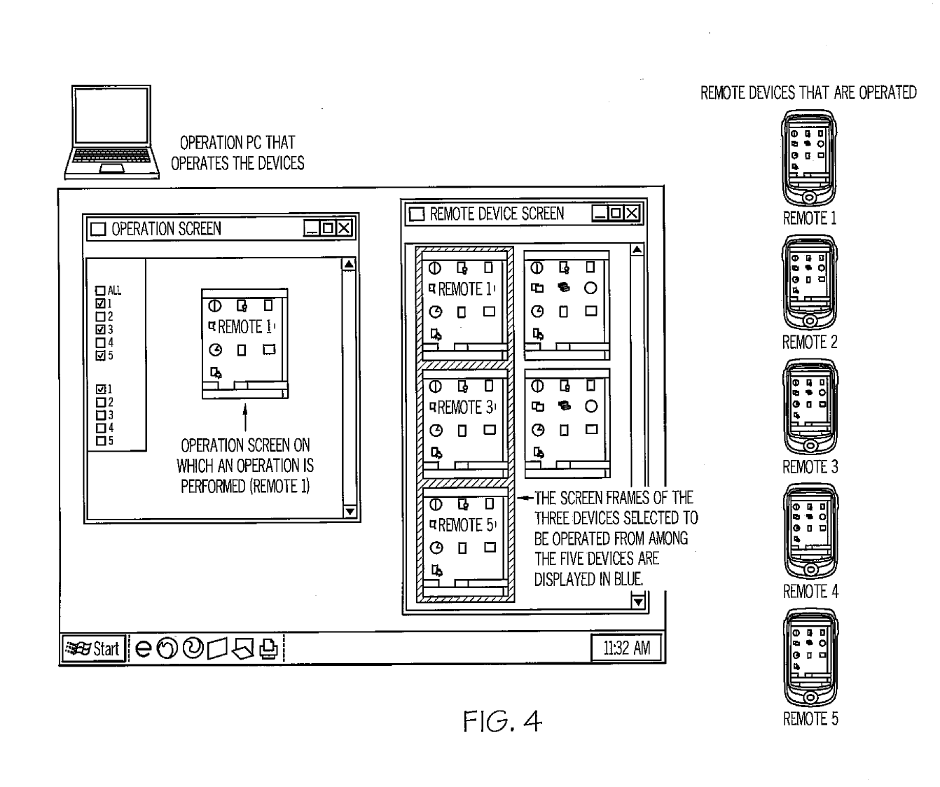

A checkbox for selecting devices to be operated is provided in view of the operability of the user. This is shown in FIG. 3. Described below are three alternatives provided for the checkbox according to the number of devices that are to be operated.
1) When all the n-plex devices are to be operated, “All” is selected in the checkbox. As a result, an operation on the operation screen is performed on all the n-plex devices. See FIG. 3 and FIG. 4 at the top left of the Operation Screen.
2) When multiple (not n-plex) devices are to be operated, the relevant device names are selected in the checkbox. See FIG. 3 and FIG. 4 at the top left of the Operation Screen. As a result, an operation on the operation screen is performed on multiple devices for which the device names have been selected. See Remote 1, 2, 3, 4, and 5 in FIG. 3 and FIG. 4.
3) When only one device is to be operated, there are two alternatives:
   a. One device is selected in the checkbox on the operation screen and is operated using the operation screen (see FIG. 3 and FIG. 4 at the top left of the Operation Screen), and
   b. With the operation screen being unused, an operation is performed by clicking and activating the screen frame of the device. As a result, the operation is performed on the device.

The system and method of the present invention provides an operation which can be performed simultaneously on multiple devices as mentioned above. See FIG. 1. In addition, because 1), 2), or 3) above can be selected in view of better operability, devices to be operated can be selected conveniently according to the purpose of use.

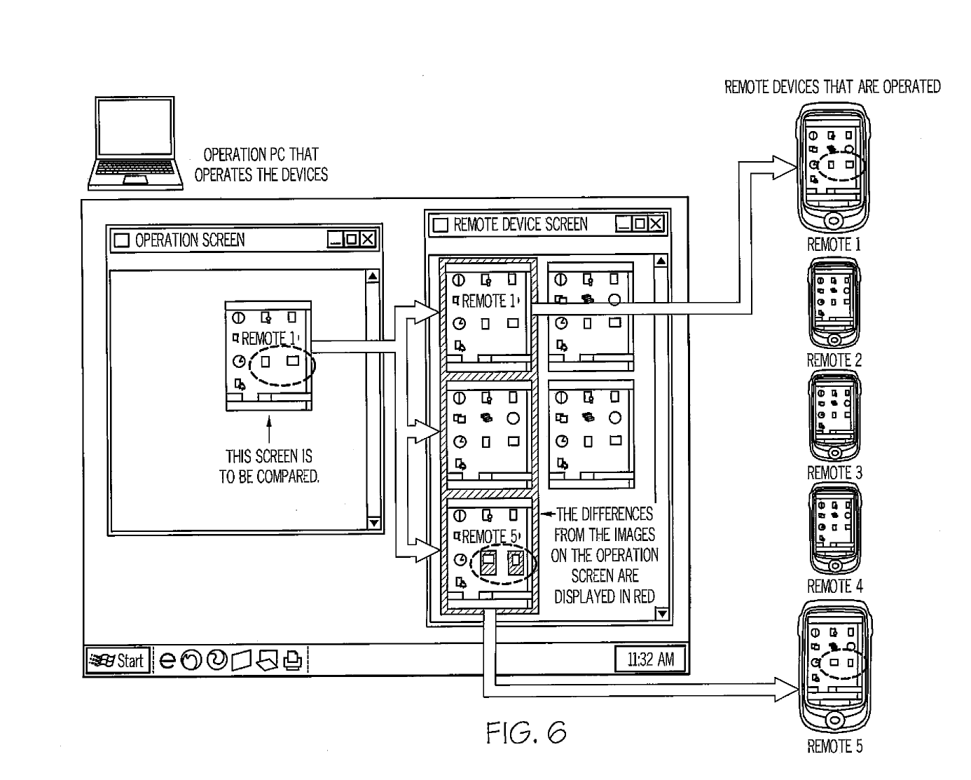

Described below are the examples of use according to 1), 2), and 3) above. Before an operation is performed, the setting screens of the 30 pocket PCs located in remote places are displayed on the local PC (see Figures for Operation PC and Remote Devices, in particular, see FIG. 3) and all the setting screens are the same.
1) When the present time is set on the 30 pocket PCs:
   In this case, select “All” in the checkbox and perform the operation on the operation screen. The 30 PCs can be operated by means of one operation.
2) When 15 of the pocket PCs are set to U.S. time and the other 15 are set to Japan time. In this case, select the 15 pocket PCs to be set to U.S. time in the checkbox and operate them on the operation screen. Next, select the other 15 pocket PCs to be set to Japan time in the checkbox and operate them on the operation screen. Each half of the 30 pocket PCs can be operated by means of one operation.
3) When the same time setting operation performed on the 30 pocket PCs causes an error to be displayed on one of the pocket PCs and the error requires correction. In this case, move the cursor onto the screen frame of the PC with an error in order to activate the screen, and then perform the operation. In view of the convenience for the user, when the screen of one of the pocket PCs differs from the operation screen (for example, the operation screen shows a clock of which the hands point to 10:00 while the screen of the pocket PC shows the error “the time cannot be set”), the difference from the operation screen is displayed in red or another different color to identify the difference. See FIG. 6. With this function, the user can visually identify the difference with ease.

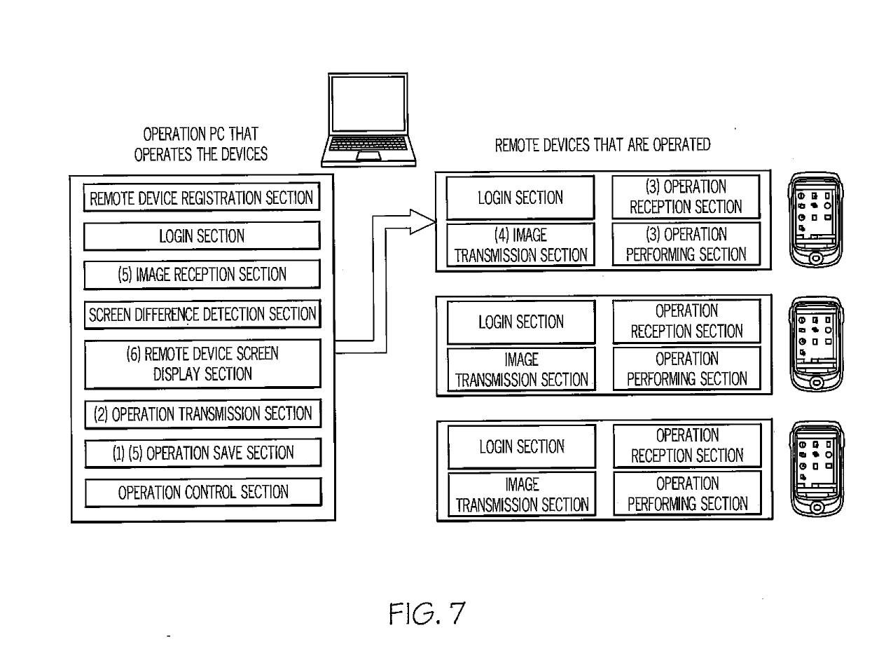

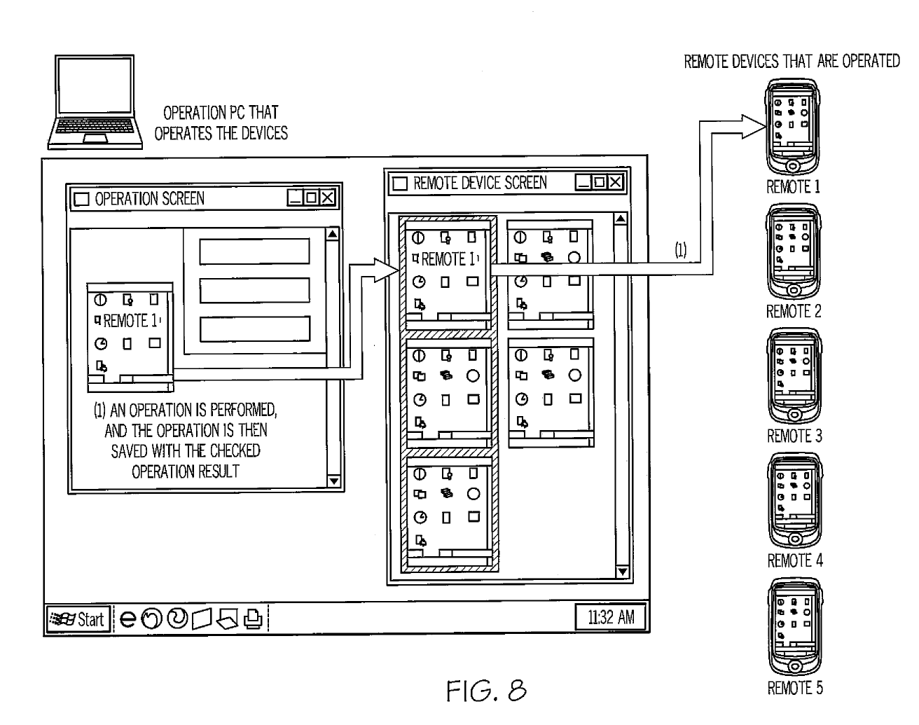

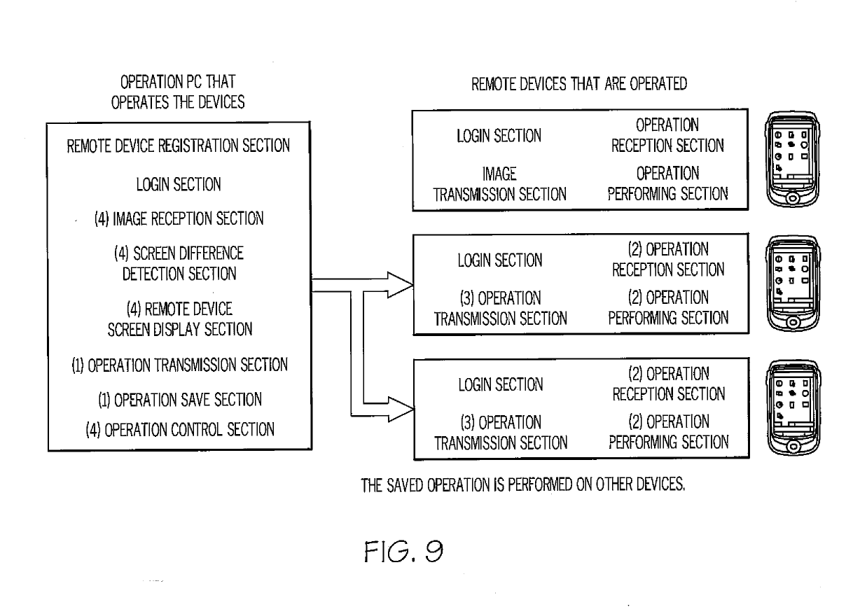

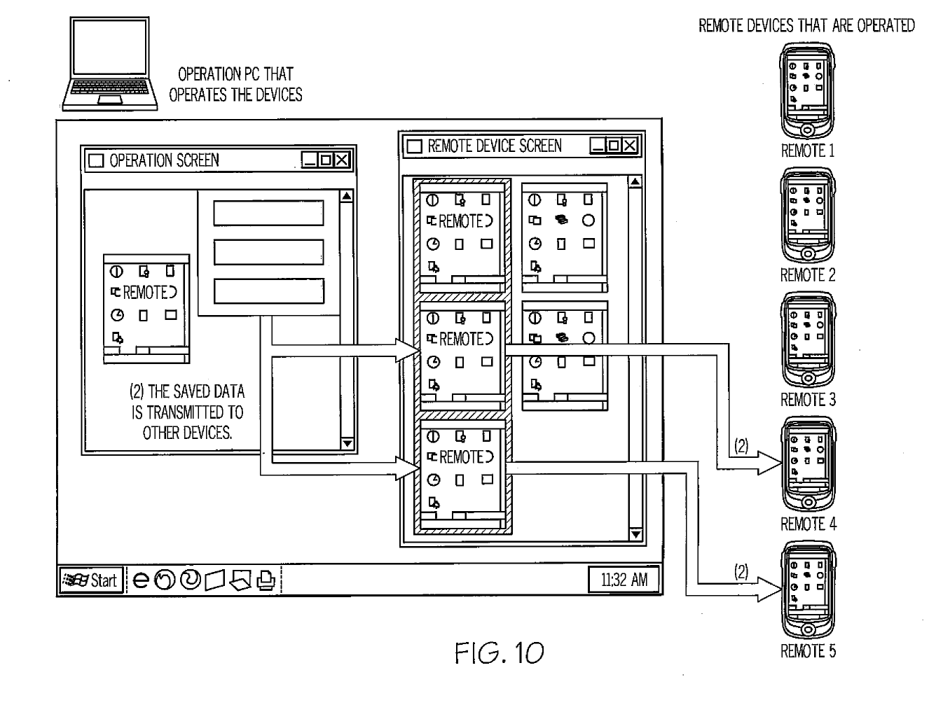

Secondly, the method for performing the operation checked on one device on multiple other devices is described below. In this method, the operation that was performed on one specific device is saved (see FIG. 7 and FIG. 8), and the saved operation is later transmitted to and performed on the other devices (see FIG. 9 and FIG. 10). The objective of this method is to prevent the simultaneous operation on all the devices from causing an error on all the devices. Using this idea, before an operation is performed on 30 devices, if it has been confirmed that the operation has proved successful on one device, it is possible to transmit the same operation to the other 29 devices and to thereby prevent an erroneous operation from being performed on all 30 devices.

If the operation result on one device is different from those on the other devices, the operation on the devices automatically stops. For example, while the operation checked on one device is performed on the other 29 devices, if the operation result on one of the 29 devices has been found to differ from the result of the checked operation, the operation will cease to perform on the 29 devices. With this function, the occurrence of an error on one device will automatically stop the operation on the rest of the devices, even though the user does not notice the occurrence of the error, thereby minimizing the number of erroneous operations. The present invention is feasible when the operations on the operation PC and the protocols sent from the remote devices are combined and saved and they are compared while the operation is performed.

In the first method, mentioned earlier, the pixel values of the screens are compared and the difference is displayed in a different color. In the second method above, a comparison is made, not of the pixel values, but of the protocols sent from the remote devices. By using the concepts of the present invention, with each of them being integrated, an operation can be performed efficiently according to the purpose of use of the user, and the reliability of operation can be improved. This remote control method can be put to practical use by developing software rather than hardware.

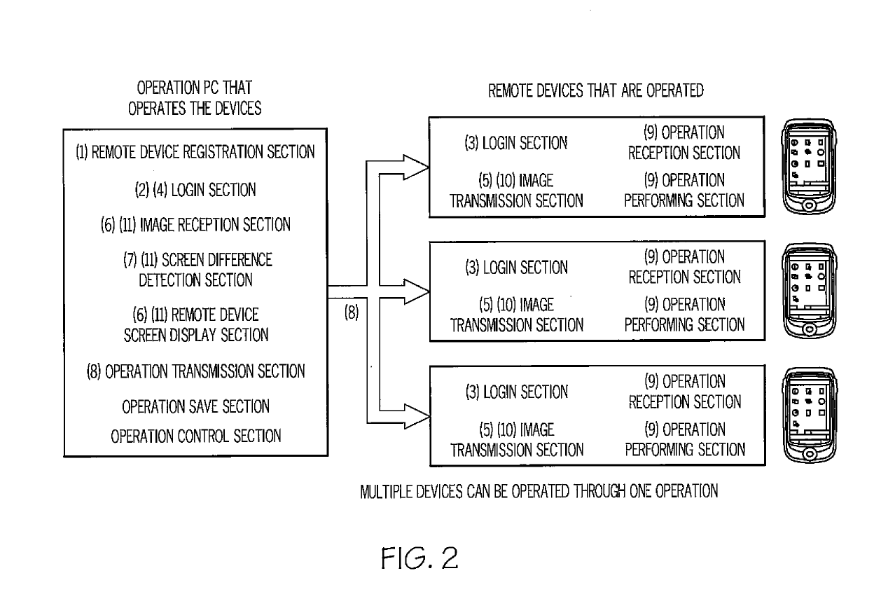

The functional block diagram is shown in FIG. 2.

In the following explanations, the device that performs an operation is called “operation PC (blue),” and the devices that are operated are called “remote devices (green).” The numbers (1) through (11) correspond to the numbers in FIG. 2.

(1) Remote Device Registration Section

In the remote device registration section of the operation PC, the IP addresses of the remote devices that are to be operated and the user IDs and passwords are registered.

(2) Login Section

The name of the remote device to be remote-controlled is selected from among the remote device names registered on the operation PC. As a result, the login section of the operation PC automatically transmits the user ID and password to the login section of each remote device.

(3) Login Section

Authentication is performed in the login section of each remote device.

(4) Login Section

A reply that the user ID and password have been authenticated comes from each remote device. When the authentication has failed, the setting items, such as the user ID and password, are rechecked.

(5) Image Transmission Section

An image of the screen of each remote device is sent from the image transmission section of each remote device to the image reception section of the operation PC simultaneously.

(6) Remote Device Screen Display Section

The image reception section of the operation PC receives the image of each remote device. The remote device screen display section of the operation PC displays the screen of each remote device (FIG. 3). An explanation of FIG. 3 is shown below.

There are two windows on the operation PC: the remote device screen that displays all the connected remote devices and the operation screen on which an operation is performed.

1. The remote device screen displays the screens of all the currently connected remote devices.

2. The operation screen displays the representative device of the remote devices to be operated.

There are two groups of checkboxes on the operation screen.

One group of checkboxes says, “Select the device to be operated”, and the device to be operated is selected from among all the remote devices.

The other group says, “Select the operation window”, and only one representative device is selected from among the devices to be operated. When the user performs an operation on the operation screen, the operation is transmitted to the devices to be operated. For example, when the button Down/Up operation is performed on the operation screen, the operation is transmitted to all the devices to be operated.

In FIG. 3, Remote 1, Remote 3, and Remote 5 have been selected as the devices to be operated, and Remote 1 has been selected as the operation screen. In this case, the remote device screen display section displays the window frames of Remote 1, Remote 3, and Remote 5 in blue, and the operation screen displays the screen of Remote 1 (see FIG. 4).

(7) Screen Difference Detection Section

In the device screen difference detection section, the pixel value of the operation screen is compared with that of the screen of each remote device. When a difference exists, it is displayed in red (see (11) for details).

(8) Operation Transmission Section

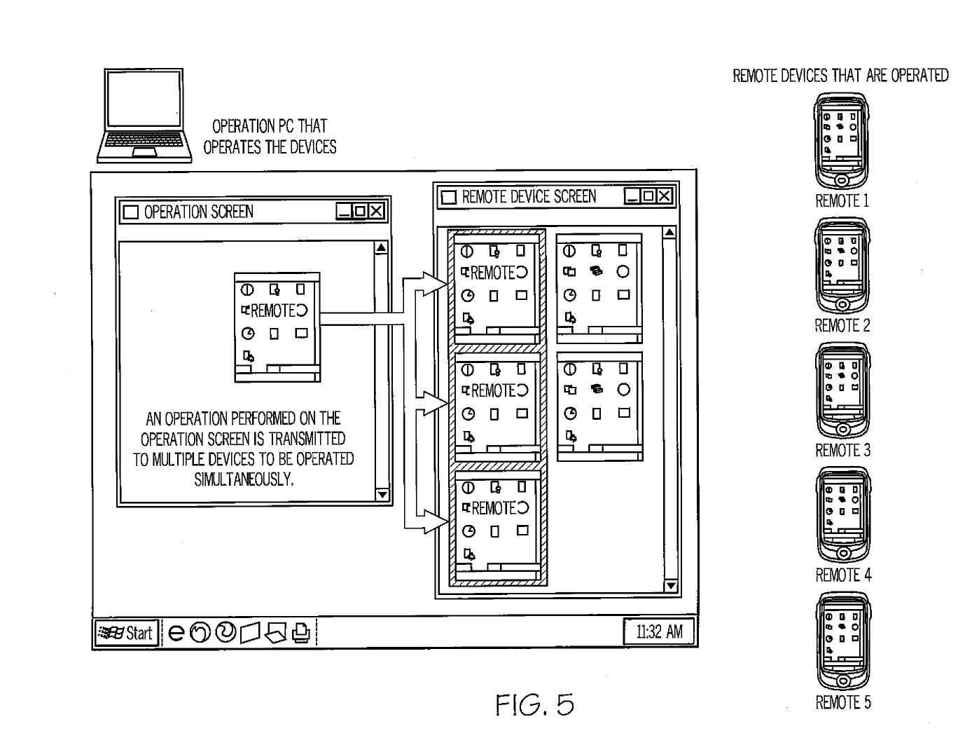

An operation (for example, double-clicking) performed on the operation screen of the operation PC is transmitted from the operation transmission section of the operation PC to the operation reception section of each remote device to be operated simultaneously (see FIG. 5). This is a new function.

This function is enabled by opening the multiple sockets of the network and transmitting data to each device simultaneously. When megabytes of data are transmitted to each device at one time, the operations of remote device 1, remote device 2, and remote device 3 are displayed in this order (not simultaneously). Therefore, after the data has been divided into units of tens of bytes, it should be transmitted to each device. With this method, the operation performed on each device can be displayed simultaneously. In the conventional method, only one of the sockets was opened at a time.

(9) Operation Reception Section and Operation Performing Section.

The operation reception section of each remote device receives the operation. After that, the operation performing section performs the received operation and updates the screen of each remote device.

An operation checked on one device is performed on multiple other devices. (The method is installed by combining the operation on the operation PC and the protocols (FillRect and DrawBitmap) sent from the remote devices and saving them.)

An unexpected operation result is automatically detected, stopping the operation to be performed. (The method is installed by comparing the saved protocols with the protocols sent from the remote devices.)

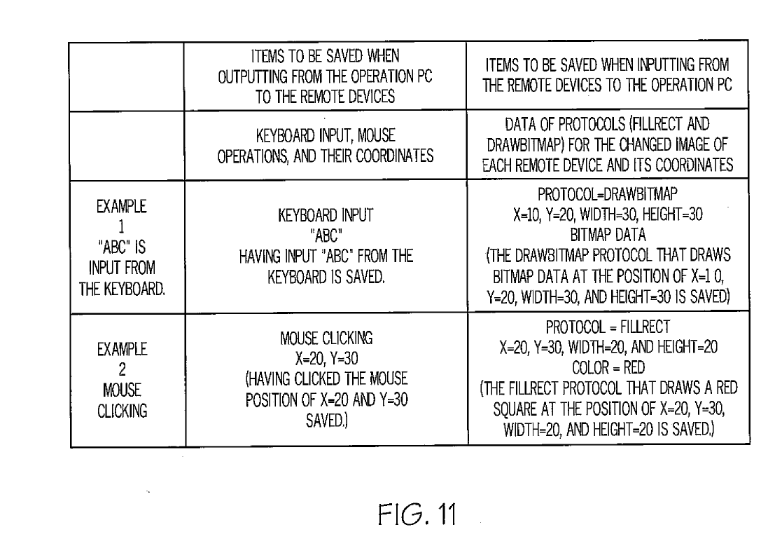

The method of the present invention has an operation which is performed on the device used as the operation screen, the operation (for example, mouse clicking and its coordinates) is saved on the operation PC, and the saved operation is later transmitted to other devices that are to be operated. When the operation is saved, the operation on the operation PC and the protocols (FillRect and DrawBitmap) are combined and saved (see Table 1 in FIG. 11). When the saved operation is performed on other remote devices and the operation results on the remote device screens are different from those of the operation screen, the operation is stopped. With this function, when a unexpected error occurs, no more operations can be performed.

In the basic flow, the pixel value of the operation screen is compared with those of the remote devices and they are displayed in different colors. On the other hand, in the operation save flow, comparison is made, not of pixel values, but of protocols sent from the remote devices.

The procedure for displaying the operation screen and remote device screens is the same as that of the basic flow.

When the user presses the save start button in the menu of the operation screen, saving of an operation begins (see FIG. 8).

An operation performed on the operation screen is saved in a file. The data to be saved are keyboard input, mouse operations, and their coordinates.

The operation transmission section of the operation PC transmits the data to the operation reception section of each remote device on the operation screen.

The operation reception section of each remote device receives the operation. Next, the operation performing section performs the received operation and updates the screen of each remote device.

Only the updated images from among the images are transmitted from the image transmission section of each remote device to the operation PC. With the following protocols being used, the screen changes of each remote device is transmitted to the operation PC.

FillRect (paints a square area in one color and sends the color value and the square coordinates); and

DrawBitmap (draws a square area in multiple colors and sends bitmap data and the upper-left coordinates of the bitmap).

Screen Reception Section and Operation Save Section

The image reception section of the operation PC receives the screen changes of each remote device, and the operation save section saves the protocols for the changes in the file.

Remote Device Screen Display Section

The screen of the operation PC is updated according to the number of screen changes. Each time an operation is performed, steps (1) through (6) are repeated. When the operation ends, the save end button is pressed.

Through this series of steps, the operations between the save start and save end and the protocols for the screen changes sent from the remote devices in response to those operations are combined and saved in a file by the operation save section (see Table 1 of FIG. 11).

The procedure for displaying the operation screen and remote device screens is the same as that of the basic flow.

The user confirms whether the operation result on the screen is the expected one. If so, the user presses “Transmit the operation to other devices” in the menu (see FIG. 10).

(1) Operation Save Section and Operation Transmission Section

The data saved in the operation save section is transmitted to the remote devices checked as devices to be operated.

(2) Operation Reception Section and Operation Performing Section

The operation reception section of each remote device receives the operation. Next, the operation performing section performs the received operation and updates the screen of each remote device.

(3) Image Transmission Section

The image transmission section of each remote device transmits only the updated images from among the images to the operation PC. With the following protocols being used, the screen changes of each remote device are transmitted to the operation PC.

(4) Screen Reception Section, Operation Control Section, Screen Difference Detection Section, and Screen Display Section

The image reception section of the operation PC receives the protocol for the changed image of each remote device.

The protocol for the changed image in the operation control section is compared with that for the changed image of each remote device, and when there are any differences (for example, when the coordinates of the DrawBitmap protocol are different), the transmission stops immediately.

After transmission stops, the protocol difference is displayed as a pixel value difference in the screen difference detection section. After that, the pixel value difference is displayed in red, etc., in the screen display section. With this function, when a unexpected error occurs, the operation can be stopped.

When there are no differences, the screens of each remote device are displayed in the remote device screen display section, and the operation continues.

Until a protocol change is detected or until the end of the saved data, operations from (1) through (4) is repeated.

(10) Image Transmission Section

The image transmission section of each remote device transmits only the updated images from among the images on the screen of each remote device to the operation PC. When the clock is operating, only the upgraded image area is transmitted to the operation PC. Each remote device transmits the screen change via the following protocols:

FillRect (paints a square area in one color and sends the color value and the square coordinates)
DrawBitmap (draws a square area in multiple colors and sends bitmap data and the upper-left coordinates of the bitmap)

(11) Image Reception Section, Screen Difference Detection Section, and Remote Device Screen Display Section

The image reception section of the operation PC receives the image, and the screen difference detection section compares the bitmap screen of the operation PC screen with that of the operation screen of each remote device. The comparison in 16 colors, color-subtracted from 32-bit full color, considerably reduces the amount of data to be compared and also reduces the amount of time required for the comparison. After the comparison, the differences are displayed in another color in the remote device screen display section (see FIG. 6). With this, the user can visually identify the difference with ease.

Other Functions:

The items that can be set are shown below.
1. The number of colors of the image sent from each remote device can be set. Full color, 256 colors, or 16 colors can be selected. When the transmission performance is not good, sending the image in color-subtracted 16 colors will reduce the amount of transmitted data; and
2. After login, the time interval between one changed image and another transmitted by each remote device can be set. When the operation PC cannot process the large amount of data transmitted simultaneously from all the remote devices, prolonging the time interval can reduce the burden on the operation PC.

The present invention is a system and operation method in which the user transmits an operation to one specific remote device and can perform the operation there by placing a cursor on the screen frame of the remote device to activate the screen. With this method, the operation screen does not need to be used.

The user can select the use of the operation screen or the use of the above method in which one specific remote device is activated, according to the purpose of use.

An operation checked on one device is performed on multiple other devices. The method is installed by combining the operation on the operation PC and the protocols (FillRect and DrawBitmap) sent from the remote devices and saving them.

An unexpected operation result is automatically detected, stopping the operation to be performed. The method is installed by comparing the saved protocols with the protocols sent from the remote devices.

The present invention is a system and method in which an operation is performed on the device used as the operation screen, the operation (for example, mouse clicking and its coordinates) is saved on the operation PC, and the saved operation is later transmitted to other devices that are to be operated. When the operation is saved, the operation on the operation PC and the protocols (FillRect and DrawBitmap) are combined and saved (see Table 1 of FIG. 11). When the saved operation is performed on other remote devices and the operation results on the remote device screens are different from those of the operation screen, the operation is stopped. With this function, when a unexpected error occurs, no more operations can be performed.

In the basic flow, the pixel value of the operation screen is compared with those of the remote devices and they are displayed in different colors. On the other hand, in the operation save flow, comparison is made, not of pixel values, but of protocols sent from the remote devices.

The procedure for displaying the operation screen and remote device screens is the same as that of the basic flow. When the user presses the save start button in the menu of the operation screen, saving of an operation begins (see FIG. 8).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for operating multiple devices using the remote control method, for operating multiple devices simultaneously, and for performing the operation checked on one device on multiple other devices, the method comprising the steps of:
a. transmitting an operation to multiple devices simultaneously;
b. detecting the differences in the result screens;
c. displaying the differences;
d. performing operations checked on one device on multiple other devices; and
e. automatically detecting unexpected operation results and stopping the operation to be performed.

2. The method of claim 1 further comprising the steps of supporting n-plex devices which are located in remote places and one screen (“operation screen”) on which remote operation is performed are displayed on a local PC display as (n+1)-plex screens.

3. The method of claim 2 further comprising the steps of performing on the operation screen (for example, moving the cursor and clicking the folder icon) and transmitting to and performing on the n-plex devices.

4. The method of claim 3 further comprising the step of displaying, simultaneously, in realtime on the n-plex screens of the local PC.

5. The method of claim 4 further comprising the step of providing a checkbox for selecting devices to be operated is provided in view of the operability of the user.

6. The method of claim 5 further comprising the steps of performing an operation checked on one device on multiple other devices.

7. The method of claim 6 further comprising the steps of saving the operation that was performed on one device is saved, and transmitting the saved operation to the devices to prevent the simultaneous operation on all the devices from causing an error on all the devices.

8. The method of claim 7 further comprising the steps of determining if the operation result on one device is different from those on the other devices and stopping the operation on the devices.

9. The method of claim 1 further comprising the steps of comparing the pixel values of the screens and displaying, on the UT, the difference between the pixel values of the screens in a different color.

10. The method of claim 1 further comprising the step of comparing the the protocols sent from the remote devices.

11. A computer program product in a computer readable medium for operating in a system comprising a network I/O, a CPU, and one or more databases, for implementing a method for operating multiple devices using the remote control method, for operating multiple devices simultaneously, and for performing the operation checked on one device on multiple other devices, the method comprising the steps of:
a. transmitting an operation to multiple devices simultaneously;
b. detecting the differences in the result screens;
c. displaying the differences;
d. performing operations checked on one device on multiple other devices; and
e. automatically detecting unexpected operation results and stopping the operation to be performed.

12. The computer program product of claim 11 wherein the method further comprises the steps of supporting n-plex devices which are located in remote places and one screen (“operation screen”) on which remote operation is performed are displayed on a local PC display as (n+1)-plex screens.

13. The computer program product of claim 11 wherein the method further comprises the steps of performing on the operation screen and transmitting to and performing on the n-plex devices.

14. The computer program product of claim 11 wherein the method further comprises the step of displaying, simultaneously, in realtime on the n-plex screens of the local PC.

15. The computer program product of claim 11 wherein the method further comprises the step of providing a checkbox for selecting devices to be operated is provided in view of the operability of the user.

16. The computer program product of claim 15 wherein the method further comprises the steps of performing an operation checked on one device on multiple other devices.

17. The computer program product of claim 16 wherein the method further comprises the steps of saving the operation that was performed on one device is saved, and transmitting the saved operation to the devices to prevent the simultaneous operation on all the devices from causing an error on all the devices.

18. The computer program product of claim 17 wherein the method further comprises the steps of determining if the operation result on one device is different from those on the other devices and stopping the operation on the devices.

19. The computer program product of claim 18 wherein the method further comprises the steps of comparing the pixel values of the screens and displaying, on the UI, the difference between the pixel values of the screens in a different color.

20. The computer program product of claim 19 wherein the method further comprises the steps comprising the step of comparing the the protocols sent from the remote devices.
